(19) United States
(12) Patent Application Publication
(10) Pub. No.: US 2004/0145643 A1
(43) Pub. Date: Jul. 29, 2004

(54) Transfer medium for inkjet recording and image formation method

(75) Inventor: Hideyuki Nakamura, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/755,471

(22) Filed: Jan. 13, 2004

(30) Foreign Application Priority Data
Jan. 24, 2003 (JP) P. 2003-016369

(51) Int. Cl. B41J 2/01

(52) U.S. Cl. 347/103

(57) ABSTRACT

A transfer medium for inkjet recording which comprises a base material, a cushion layer, a release layer having a thickness of from 0.02 to 10 μm and a transfer layer having a thickness of from 0.02 to 20 μm; and an image formation method which comprises inkjet recording on a transfer face of the transfer medium, the transfer medium comprising a base material, a cushion layer, a release layer having a thickness of from 0.02 to 10 μm and a transfer layer having a thickness of from 0.02 to 20 μm, with the use of an ink containing a pigment or a dye as a coloring matter, locating face-to-face a transfer substrate and the transfer face of the transfer medium, heating and pressurizing, and stripping off the transfer medium from the transfer substrate to thereby transfer the transfer layer and the release layer onto the transfer substrate.

### FIELD OF THE INVENTION

This invention relates to a transfer medium for ink-jet recording and an image formation method.

### BACKGROUND OF THE INVENTION

With the improvements in the image qualities, use of inkjet printing system has been expanded in the fields of photographs, proofs and so on. Thanks to elevated accuracy in color matching, this system is also employed in correcting proofs with a need for strict color reproducibility. In inkjet recording media, it has been a practice to employ specialty papers to impart ink-receiving properties thereto. In the case of using in proofs, use is made of inkjet papers for proofs having color tone and gloss approximate to printing papers. However, printing papers widely vary in color tone, gloss, thickness, etc. so that it is difficult to prepare inkjet papers closely similar to individual printing papers.

To match various types of papers, there has been proposed a method which comprises once forming an inkjet image on an intermediate transfer medium for inkjet and then transferring a transfer layer having the thus recorded image onto a transfer substrate serving as the final base material such as a printing paper.

As a method of forming an image by the inkjet system on an intermediate transfer medium and then transferring the image onto a transfer substrate, JP-A-11-42896 and JP-A-2000-1044 propose intermediate media having a release layer and a releasable transfer layer on a base material.

However, these intermediate media suffer from some problems in the image qualities as proofs, for example, having insufficient transferability to printing papers with high surface roughness such as matt paper or woodfree paper, the transfer layer of the intermediate showing a transferred image with low transparency and murky colors, or the gloss of the image formation layer being largely different from that of the printing paper.

### SUMMARY OF THE INVENTION

An object of the invention is to provide a transfer medium for inkjet recording which has a favorable transferability onto various printing papers (i.e., differing in surface roughness, gloss, thickness, surface-treatment on the paper face, etc.) employed as transfer substrates and providing an image having a gloss highly approximate to the printing paper even in a non-image area.

Another object of the invention is to provide an image recording method with the use of the transfer medium for ink-jet recording having excellent properties as described above.

According to the invention, a transfer medium for ink-jet recording of the following constitution and an image recording method are provided so as to achieve the above-described objects of the invention.

1. A transfer medium for inkjet recording which comprises, on a base material, at least a cushion layer, a release layer having a film thickness of from 0.02 to 10 μm and a transfer layer having a film thickness of from 0.02 to 20 μm.

2. A transfer medium for inkjet recording according to the above 1 wherein the permeability of the release layer at from 400 to 700 nm is 70% or more.

3. A transfer medium for inkjet recording according to the above 1 or 2 wherein the transfer layer can absorb an ink solvent.

4. A transfer medium for inkjet recording according to the above 1 or 2 wherein the cushion layer can absorb an ink solvent.

5. A transfer medium for inkjet recording according to any of the above 1 to 4 wherein the interlayer adhesion between the release layer and the cushion layer is from 0.5 to 400 g/cm.

6. A transfer medium for inkjet recording according to any of the above 1 to 5 wherein the release layer and the transfer layer are simultaneously transferred onto a transfer substrate.

7. A transfer medium for inkjet recording according to any of the above 1 to 6 wherein the transfer layer or the release layer contains matt grains.

8. An image formation method which comprises ink-jet recording on the transfer face of a transfer medium for ink-jet recording according to any of the above 1 to 7 with the use of an ink containing a pigment or a dye as a coloring matter, subsequently locating face-to-face a transfer substrate and the transfer face of the transfer medium for inkjet recording, heating and pressurizing, and then stripping ff the transfer medium for inkjet recording from the transfer substrate to thereby transfer the transfer layer and the release layer onto the transfer substrate.

### DETAILED DESCRIPTION OF THE INVENTION

Now, the invention will be described in greater detail.

The transfer medium for inkjet recording according to the invention comprises, on a base material, at least a cushion layer, a release layer having a film thickness of from 0.02 to 10 μm and a transfer layer having a film thickness of from 0.02 to 20 μm. Next, each layer constituting the transfer medium for inkjet recording will be illustrated.

[Cushion Layer]

The cushion layer to be formed in the transfer medium for inkjet recording according to the invention is a layer having cushion properties. As indications showing the cushion properties as described above, use can be made of the modulus of elasticity and the degree of penetration. For example, it has been confirmed that a layer having a modulus of elasticity at 25° C. of from about 1 to 250 kg/mm² or a degree of penetration as defined in JIS K2530-1976 of from about 15 to 500 shows cushion properties appropriate for the formation of a color proof image for color proofing, though the extent of the required cushion properties varies depending on the desired use of the image.

A preferable cushion layer has a TMA softening point (i.e., the softening point measured by Thermomechanical Analysis) of 60° C. or below, still preferably 45° C. or below.

The TMA softening point is determined by heating a subject to be measured at a definite heating speed while applying a definite load thereon and then observing the phase of the subject to be measured.

In the invention, the TMA softening point is defined as the temperature at which the phase of a subject to be measured begins to change. The softening point by TMA can be measured by using an apparatus, for example, a Thermoflex (manufactured by Rigaku Denki K. K.). In the case where Thermoflex is employed and the measurement temperature ranges from 25° C. to 200° C. and a heating speed is adjusted to 5° C./min, for example, the temperature at which the phase of a quartz glass pin of 1 mm in diameter begins to change under a load of 5 g is regarded as the TMA softening point.

Although favorable properties of the cushion layer according to the invention cannot be always specified due to the type of its material, examples of materials having favorable properties per se include ethylene-vinyl acetate copolymer, ethylene-ethyl acrylate copolymer, polybutadiene resins, styrene-butadiene copolymer (SBR), styrene-ethylene-butene-styrene copolymer (SEBS), acrylonitrile-butadiene copolymer (NBR), polyisoprene resins (IR), styrene-isoprene copolymer (SIS), acrylic acid ester copolymer, polyester resins, polyurethane resins, acrylic resins, butyl rubber, polynorbornene and so on.

Among them, materials having a relatively low molecular weight are liable to fulfill the requirements of the invention, though the invention is not particularly restricted to specific materials.

Using materials other than those cited above, it is also possible to impart preferable properties to the cushion layer by adding various additives.

As the additives, low-melting substances such as waxes and plasticizers may be cited. Specific examples thereof include phthalic acidesters, adipic acidesters, glycol esters, fatty acid esters, phosphoric acid esters, chloroparaffin and so on. For example, use can be made of various additives cited in Purasuchikku oyobi Gomu-yo Tenkazai Binran, Kagaku Kogyo-sha (1970), etc.

The addition level of such an additive is not particularly restricted. Namely, it may be used in an amount appropriate for the expression of favorable properties when combined with the cushion layer material employed as a base. In general, it is preferable to add such an additive in an amount of 10% by mass or less, still preferably 5% by mass or less, based on the cushion layer material.

By providing the cushion layer, the transferability can be improved even in the case of using a printing paper having a high surface roughness. Printing papers usually have roughness of several μm or more. Matt paper and woodfree paper have irregularities of ten-odd μm or more. In order to make the transfer layer to follow these irregularities, it is preferable to form a thermoplastic cushion layer having a Vicat softening point of 80° C. or below and a thickness of 10 μm or more, still preferably 15 μm or more. In the case of re-transferring onto another transfer substrate (for example, paper such as coated paper or woodfree paper), furthermore, it is preferable that the film thickness of the cushion layer is 30 μm or more. When the film thickness of the cushion layer is less than 10 μm, defects or voids sometimes arise in the step of re-transferring onto the final transfer substrate. The upper limit of the film thickness of the cushion layer is preferably 50 μm, still preferably 20 μm.

It is preferable in the invention that the cushion layer can absorb a solvent of an ink to be used in inkjet recording.

An ink to be used in inkjet recording usually contains a high-boiling hydrophilic solvent. When a high-boiling hydrophilic solvent exists at a high concentration in a transfer layer containing dye-fixing sites in the case of using a dye as a coloring matter, the fixed dye would diffuse via the solvent with the passage of time. As a result, the resolution is worsened by bleeding and the density or the color hue is changed. In the case where the cushion layer can absorb the ink solvent, the solvent is absorbed by the cushion layer and therefore the solvent concentration in the transfer layer is lowered. Thus, it is possible to prevent the worsening in the resolution or changes in the density or the color hue.

Ink absorbency can be imparted to the cushion layer by forming a porous cushion layer or appropriately selecting a polymer to be used in a solvent absorbent paper.

[Release Layer]

To enhance the transferability of the transfer layer onto a printing paper, the transfer medium for inkjet recording according to the invention has a release layer having a film thickness of from 0.02 to 10 μm between the transfer layer and the cushion layer. The interlayer adhesion between the release layer and the cushion layer is preferably from 0.5 to 400 g/cm, still preferably from 2 to 50 g/cm. When the interlayer adhesion is less than 0.5 g/cm, the transfer layer has only a poor adhesiveness and, therefore, frequently peels off when a sheet is folded or an ink is typed in. When the interlayer adhesion exceeds 400 g/cm, on the other hand, no transferability onto a printing paper can be obtained.

The permeability of the release layer at 400 to 700 nm is preferably 70% or more, still preferably 80% or more and still preferably 90% or more. By controlling the permeability of the release layer to the level as specified above, print approximation can be improved.

To approximate the gloss of the transfer layer in a non-image area to the gloss of a printing paper, it is preferable to use a transfer layer material which has a higher softening point than the cushion layer. By selecting the above-described cushion layer and a transfer layer made of such a material, it becomes possible that the transfer layer shows a low gloss in the case of being transferred onto a paper having a rough surface and a low gloss while it shows a high gloss in the case of being transferred onto a paper having a low surface roughness and a high gloss.

Specific examples of the binder in the release layer include polyester, polyvinyl acetal, polyvinyl formal, polyparabanic acid, polymethyl methacrylate, polycarbonate, ethylcellulose, nitrocellulose, methylcellulose, carboxymethylcellulose, hydroxypropylcellulose, polyvinyl alcohol, polyvinyl chloride, styrenes such as polystyrene and acrylonitrile styrene, crosslinked products of these resins, thermosetting resins having Tg of 65° C. or more such as polyamide, polyimide, polyether imide, polysulfone, polyether sulfone and aramid, and hardened products of these resins. As a hardening agent, use can be made of hardening agents commonly employed such as isocyanate and melamine.

In the release layer, use can be made of matt grains, for example, resin grains which are preferably added in the transfer layer as will be described hereinafter. By adding these matt grains, the integration properties and rubfastness of the image-receiving layer are improved and thus favorable results can be obtained.

As described above, the film thickness of the release layer is from 0.02 to 10 μm, preferably from 0.02 to 1 μm. When the film thickness of the release layer falls within the range as defined above, excellent effects can be obtained in print approximation, etc. When the film thickness is less than 0.2 μm, the interlayer release balance becomes unclear. When it exceeds 10 μm, dot gain is increased. Both of these cases are undesirable from the viewpoint of print approximation.

[Transfer Layer]

It is preferable that the transfer layer according to the invention having heat transferability and aqueous ink receiving properties has a porous structure so as to improve its ink absorbency, similar to JP-A-11-42896. To elevate the transferability onto a printing paper, it is also preferable to impart heat transferability to the transfer layer by using a thermoplastic resin. For the simultaneous pursuit of the ink absorbency and the heat transferability, it is preferable to use fine grains of a thermoplastic resin. It is still preferable that these thermoplastic resin grains are porous ones.

The fine porous grains of a thermoplastic resin preferably usable in the transfer layer according to the invention are exemplified by fine porous grains made of a water-insoluble thermoplastic resin. In the case where the transfer layer contains such fine grains of a thermoplastic resin, these grains are not made into a film but exist while keeping the shape of the grains in the transfer layer before the formation of a transfer image, thereby making the transfer layer porous. When an ink is supplied to the transfer layer by the inkjet recording system, therefore, the ink is well absorbed in the voids among these fine grains and thus well sustained. When fine porous particles of a thermoplastic resin are employed in this case, the ink is also absorbed in the voids of the fine grains and thus the ink absorbency of the transfer layer is further improved. It is preferable that the fine thermoplastic grains as described above are employed in an amount of from about 30% by mass to 90% by mass based on the all of the materials constituting the transfer layer.

In the case where an image is bonded to a transfer substrate (for example, a printing paper) and then transferred by, for example, heating and pressurizing in the side of the base material of the transfer substrate, on the other hand, the fine grains of a thermoplastic resin in the transfer layer are fused and transferred onto the transfer substrate. Since these fine grains are made into a film too, a coloring matter can be fixed in a favorable state to the transfer substrate.

As a material forming the transfer layer together with the fine porous grains of a thermoplastic resin as described above, it is preferable to employ a binder. The binder is added to form a film by binding the above-described fine grains of a thermoplastic resin to each other so as to form the transfer layer, as well as to bind the transfer layer thus formed onto a transfer substrate in the transfer step. Similar to the fine porous grains of a thermoplastic resin as described above, a publicly known water-insoluble thermoplastic resin is usable as the binder. More specifically speaking, use can be made as the binder of the materials cited above for materials of the fine grains of a thermoplastic resin. It is preferable that such a binder is used in an amount of from 10 to 70% by mass based on the all of the materials constituting the transfer layer.

By adding matt grains to the transfer layer, the integration properties and rubfastness of the image-receiving layer are improved. It is preferable to use the above fine grains of a thermoplastic resin which also serve as the matt grains.

When the transfer layer is formed by exclusively using the two materials as described above, there arises no problem in the case where the melting point or the softening point of the fine grains of a thermoplastic resin or the binder is relatively low. In the case where the melting point or the softening point thereof is high, however, the transfer layer can be only insufficiently transferred. In such a case, it is therefore preferable to add a plasticizer for the fine grains of a thermoplastic resin or a plasticizer for the binder.

By adding the plasticizer, the melt viscosity of the transfer layer can be lowered in the step of heating and transferring the thus formed image and, at the same time, the adhesion to a transfer substrate can be elevated to thereby improve the transferability. Owing to the use of the plasticizer, moreover, strength and flexibility can be imparted to the transfer image so that a transfer image having an excellent texture can be formed on the transfer substrate such as a printing paper. It is preferable that such a plasticizer is used in an amount of from about 1 to 20% by mass based on the all of the materials constituting the transfer layer.

The above-described effects can be achieved by adding the plasticizer as described above. When the transfer medium thus formed is left at a high temperature or under a high humidity before forming an image, however, the formed image sometimes shows irregular colors. The occurrence of the color irregularities can be prevented by adding from 1.0 to 5.0% by mass of a fluorinated surfactant to the materials constituting the transfer layer.

To improve the affinity to a dye, it is preferable to add a cationic compound such as a cationic resin or cationic inorganic grains to the transfer layer. By adding the cationic compound, it is possible to achieve an effect of inhibiting color changes after recording with the use of a dye ink in the case of using a recording method wherein the ink is transferred onto the transfer layer and then an image is re-transferred by heating and pressurizing.

As discussed above, the interlayer adhesion between the release layer and the cushion layer in the invention preferably ranges from 0.5 to 400 g/cm. By controlling the interlayer adhesion within the range as specified above, the image surface is protected by the release layer in the step of stripping off the transfer medium for inkjet recording from a transfer substrate and thus transferring the transfer layer together with the release layer onto the transfer substrate to thereby transfer an image formed on the transfer layer surface onto the transfer substrate such as paper. Thus, favorable transferability can be achieved on various printing papers (i.e., transfer substrates) differing from each other in surface roughness, gloss, thickness, surface-treatment on the paper face, etc. and an image having a gloss highly approximate to the gloss of a printing paper can be obtained.

It is preferable in the invention that the cushion layer can absorb an ink solvent to be used in inkjet recording. Alternatively, the transfer layer may absorb an ink solvent, which is another preferable embodiment. In the case where the transfer layer can absorb the ink solvent, the ink solvent can be diffused in the whole transfer layer and the solvent concentration can be thus lowered. As a result, the diffusion of a dye can be lessened so that the worsening in the resolution or changes in the density or the color hue can be prevented.

Ink solvent-absorbency can be imparted to the transfer layer by using an appropriate polymer capable of absorbing an ink.

[Materials to be used in producing transfer medium for ink-jet recording]

Next, materials to be used in the transfer medium for inkjet recording according to the invention will be specifically described, though illustration on materials having been already described in detail is omitted.

Concerning the material of the fine grains of a thermoplastic resin, use may be made of any fine grains made of a water-insoluble thermoplastic resin. Examples of such thermoplastic resins include polyethylene, polypropylene, polyvinyl acetate, water-insoluble polyvinyl alcohol, polyvinyl acetal, poly(meth)acrylic acid copolymers, poly (meth) acrylic acid esters, polyacrylic acid derivatives, polyacrylic acid amide, polyether, polyester, polycarbonate, cellulose-base resins, polyacrylonitrile, polyimide, polyamide (nylon), polyvinyl chloride, polyvinylidene chloride, polystyrene, thiocol, polysulfone, polyurethane and copolymers of these resin monomers. Among all, it is preferable to use polyethylene, polypropylene, poly(meth)acrylic acid copolymers, poly (meth) acrylic acid esters, polyvinyl acetate, polyvinyl chloride, polyurethane, polyamide (nylon), copolymers of these monomers, etc.

It is preferable from the viewpoints of ink absorbency and image clearness that the grain diameter of the fine particles of a thermoplastic resin to be used in the invention falls within the range of from 0.05 μm to 100 μm, still preferably form 0.2 to 50 μm and till preferably from 5 to 20 μm. When grains having a grain diameter smaller than 0.05 μm are employed, the voids among the grains become too small in the step of forming the transfer layer and, as a result, any sufficient ink absorbency cannot be obtained in some cases. When the grains are too small, furthermore, the smoothness of the transfer layer surface is elevated. As a result, there arises a tendency that a transfer image is formed as a uniform continuous film on the surface of a transfer substrate. In such a case, the transfer image is liable to peel or, upon the deformation of the transfer substrate, crack and thus a favorable transfer image can be hardly obtained. When grains having a grain diameter exceeding 100 μm are used, on the other hand, the resolution of the image is worsened and a clear image can be hardly obtained.

As the fine grains of thermoplastic rein made of the material as cited above to be used in the invention, it is preferable to use fine porous grains. By using fine porous grains of a thermoplastic resin in the transfer layer in the invention, the ink absorbency of the transfer layer can be further improved. As a result, a larger amount of an ink can be absorbed by the transfer layer having the less layer thickness and it is therefore possible to obtain a thin transfer layer whereby a clear image can be formed. Moreover, such a thinner transfer layer facilitates the transfer of an image.

In the invention, it is preferable to use, as a material forming the transfer layer, fine grains of a thermoplastic resin made of a copolymer of a nylon 6 monomer with a nylon 12 monomer. Using these fine grains, the color development of a dye can be improved and an image having an elevated clearness can be obtained.

The above-described fine grains of a thermoplastic resin to be added to the transfer layer may be also added to the cushion layer. Namely, matt grains may be added to the cushion layer in order to improve slipperiness, integration properties and rubfastness. The fine grains of a thermoplastic resin as described above also serve as the matt grains.

As the fine grains of a thermoplastic resin to be used in the invention, it is preferable to employ a material which can be sufficiently fused with the use of a home pressing iron or the like and transferred onto a transfer substrate such as a paper so that an image formed by an inkjet printer for general use can be easily transferred at home, etc.

From this viewpoint, it is preferable that the melting point of the fine grains of a thermoplastic resin to be used in the invention ranges from 70° C. to 200° C., still preferably from 80° C. to 180° C. and still preferably from 100° C. to 150° C. When the melting point is lower than 70° C., it is feared that the fine grains are made into a continuous film depending on the delivery or storage conditions. After coating, drying should be carried out at a temperature lower than the melting point of the fine grains. Therefore, it is preferable to use a resin having a melting point of 70° C. or higher from the viewpoint of the production efficiency too. When the melting point is higher than 200° C., on the other hand, much energy is needed in transferring and thus it becomes difficult to easily form a transfer image on a transfer substrate such as a paper.

In the invention, furthermore, it is preferable to use fine grains of a thermoplastic resin having a low hot melt viscosity by taking the adhesion of the transfer layer to a transfer substrate into consideration. In case of using a resin having a high hot melt viscosity, the adhesion between the transfer layer and the transfer substrate is worsened and thus the transfer layer converted into a film is liable to peel off. Using a material having a low hot melt viscosity, in contrast thereto, a favorable transfer image can be obtained.

Next, a plasticizer, which is to be added to the fine grains of a thermoplastic resin and the binder as described above so as to impart strength and flexibility to a transfer substrate (for example, a paper) after transferring the transfer layer and give an excellent texture to the transfer paper or the like, will be illustrated. Preferable examples of the binder include phthalic acid esters such as diethyl phthalate, dioctyl phthalate, dimethyl phthalate and dibutyl phthalate, phosphoric acid esters such as tributyl phosphate and triphenyl phosphate, adipic acid esters such as octyl adipate and isononyl adipate, sebacic acid esters such as dibutyl sebacate and dioctyl sebacate, acetyltributyl citrate, acetyltriethyl citrate, dibutyl maleate, diethylhexyl maleate, dibutyl fumarate, trimellitic acid-base plasticizers, polyester-base plasticizers, epoxy-base plasticizers, stearin-base plasticizers, chloroparaffin, toluene sulfonamide and its derivatives, p-oxybenzoic acid-2-ethylhexyl ester, etc.

Next, a fluorinated surfactant to be added to the transfer layer made of the above materials will be illustrated. Preferable examples of the fluorinated surfactant include fluoroalkyl (C₂ to C₁₀) carboxylic acids, disodium N-perfluorooctanesulfonylglutamate, sodium 3-[fluoroalkyl (C₆ to C₁₁)oxy]-1-alkyl (C₃ to C₄) sulfonate, sodium 3-[ω-fluoroalkanoyl (C₆ to C₈)-N-ethylamino]-1-propanesulfonate, N-[3-(perfluorooctanesulfonamide)propyl]-N,N-dimethyl-N-ca rboxymethyleneammonium betaine, fluoroalkyl (C₁₁ to C₂₀) carboxylic acids, perfluoroalkyl (C₇ to C₁₃) carboxylic acids, perfluorooctanesulfonic acid diethanolamide, perfluoroalkyl(C₄ to C₁₂) sulfonic acid salts (Li, K and Na), N-propyl-N-(2-hydroxyethyl)perfluorooctansulfonamide, perfluoroalkyl(C₈ to C₁₀)sulfonamide propyltrimethylammonium salt, perfluoroalkyl (C₆ to C₁₀)-N-ethylsulfonylglycine salt (K), bis(N-perfluorooctylsulfonyl-N-ethylaminoethyl) phosphate, monoperfluoroalkyl(C₆ to C₁₆)ethyl phosphoric acid ester, perfluoroalkylbetain, etc.

Next, a cationic resin preferably employed in the transfer layer will be illustrated. As described above, the cationic resin can be added to elevate the affinity between the transfer layer and a dye. Examples of the cationic resin include cationized products of resins such as polyvinyl alcohol, hydroxyethylcellulose and polyvinylpyrrolidone, amine-type monomers such as allylamine, diallylamine, allylsulfone, dimethylallylsulfone and diallyldimethylamonium chloride, polymers and copolymers of acryl monomers having a primary to tertiary amine or a quaternary ammonium base in a side chain such as dimethylaminoethyl (meth)acrylate, diethylaminoethyl (meth)acrylate, methylethylaminoethyl (meth)acrylate, dimethylaminostyrene, diethylaminostyrene, methylethylaminostyrene, N-methylacrylamide, N-dimethylacrylamide, N,N-dimethylaminoethylmethacrylamide, quaternary compounds thereof and resins having a primary to tertiary amine or a quaternary ammonium base in the main chain such as dicyanamide.

Further, inorganic grains preferably employed together with the above-described cationic resin in the transfer layer will be illustrated. The inorganic grains to be used in the invention may be arbitrary ones so long as being porous and having ink-absorbency. Specific examples thereof include silica, aluminum silicate, magnesium silicate, hydrotalcite, calcium carbonate, titanium oxide, clay, talc, (basic) magnesium carbonate, etc.

To improve the permeation of an ink, the transfer layer in the transfer medium for inkjet recording according to the invention may contain an additional surfactant other than the fluorinated surfactant as described above. That is to say, addition of a surfactant to the transfer layer contributes to the improvement of the wettability of the grain surface and thus the penetration of a water-base ink can be elevated. As the surfactant to be used in the invention, use can be made of nonionic surfactants commonly employed. More specifically speaking, use can be made of surfactants of the ether type, the ester type, the ether/ester type, the nitrogen-containing type and so on.

As a material of the release layer constituting the transfer medium for inkjet recording according to the invention together with the transfer layer having the constitution as described above, use may be made of thermofusible materials, for example, waxes such as Carnauba wax, paraffin wax, microcrystalline wax and castor wax, higher fatty acids and derivatives thereof, e.g., metal salts andesters such as stearic acid, palmitic acid, lauric acid, aluminum stearate, lead stearate, barium stearate, zinc stearate, zinc palmitate, methyl hydroxystearate, glycerol monohydroxystearate and glycerol monohydroxystearate, polyamide type resins, petroleum resins, rosin derivatives, coumarone-indene resins, terpene type resins, novolac type resins, styrene type resins, polyethylene, polypropylene, polybutene, olefin type resins such as polyolefin oxide, vinyl ether type resins, etc. In addition, it is also possible to use silicone resins, fluorosilicone resins, fluoroolefin vinyl ether ter polymer, perfluoroepoxy resins, thermosetting acrylic resins having a perfluoroalkyl group in a side chain, vinylidene fluoride type setting resins, etc.

The transfer medium for inkjet recording according to the invention has a release layer made of such a material as described above on the base material. The base material to be used in the invention may be an arbitrary base material so long as it can be fed in a printer and has such a heat resistance as required in heat transfer. Specific examples thereof include films of polyester, diacetate, triacetate, acrylic polymers, polycarbonate, polyvinyl chloride, polyimide, cellophane, celluloid, etc., papers and woven fabrics and nonwoven fabrics made of various fibers. The transfer medium for ink-jet recording according to the invention can adequately fit its shape to a transfer substrate, even in the case of using a flexible base material such as a woven fabric or a nonwoven fabric or the transfer substrate in the form of a film having a curved face. Namely, the transfer medium for inkjet recording according to the invention enables favorable transfer onto a material having a non-planer face.

Examples of a method of forming the cushion layer, the release layer and the transfer layer on the base material include a method which comprises dissolving or dispersing adequate materials for the release layer and the transfer layer as described above in an appropriate solvent to give coating solutions and then coating the base material with the coating solutions, a method of forming films by using these materials and laminating on the base material, a method of extrusion molding, and so on. Examples of the coating method include the roll coater method, the blade coater method, the air knife coater method, the gate roll coater method, the bar coater method, the size pressing method, the SymSizer method, the spray coating method, the gravure coating method, the curtain coating method, etc.

The transfer medium for inkjet recording according to the invention as described above is put into an inkjet recorder. Then an ink is discharged and jetted toward the transfer layer by the inkjet recording method and thus an ink image is formed on the transfer face of the transfer layer. Next, the transfer layer and the release layer are simultaneously transferred onto a transfer substrate and thus the image on the transfer face is transferred onto the transfer substrate such as a paper. That is, the transfer medium for inkjet recording according to the invention is used as an intermediate transfer medium in forming a transfer image on the transfer substrate.

In the invention, the heating and pressurizing conditions in the step of transfer are not particularly restricted. It is preferable to appropriately select the optimum conditions depending on the materials constituting the transfer layer. For example, the optimum conditions are determined by taking into consideration the melting points of the fine grains of a thermoplastic resin and the thermoplastic resin binder, the heat resistance of the transfer substrate and so on. As the inkjet printer, use may be made of a marketed printer for general use as such. As the coloring matters to be used, use may be also made of publicly known anionic coloring matters without specific restriction.

### EXAMPLES

Now, the invention will be described in greater detail by reference to the following Examples. However, it is to be understood that the invention is not construed as being limited thereto.

Unless otherwise noted, all “parts” and “%” are by mass.

### Example 1

On one face of a PET film (TORAY Co., Ltd., T600) of 75 μm in thickness, an EVA resin (DUPONT MITSUI POLYCHEMICAL Co., Ltd., P1407C) was coated by the extrusion laminate processing method to give a cushion layer having a thickness of 25 μm. On this cushion layer, an ethanol solution (solid content: 10%) of polyvinyl butyral (PVB-2000L, manufactured by KURARAY Co., Ltd.) employed as a binder was coated with a wire bar to give a release layer having a dry thickness of 0.5 μm. Next, the following coating solution for transfer layer was coated with a whirler and dried at 100° C. for 2 minutes to give a transfer layer having a dry thickness of 1.5 μm, thereby giving the transfer medium for inkjet recording according to the invention. The interlayer adhesion between the cushion layer and the release layer was 25 g/cm.

### Comparative Example 1

A comparative transfer medium for inkjet recording was produced as in Example 1 but forming no cushion layer.

(Coating Solution for Transfer Layer)

To 90 parts of an alumina sol (Super 120-100: manufactured by NISSAN CHEMICAL INDUSTRIES, Ltd., a colloidal solution having a solid content of 10% and comprising amorphous cationic alumina hydrate dispersed in water) employed as cationic fine grains (matt grains) was added 5 parts of dodecylbenzenesulfonic acid and the mixture was ultrasonically dispersed for 20 minutes. To the resultant dispersion, 10 parts of a 10% aqueous solution of polyvinyl alcohol (PVA-25: manufactured by KURARAY Co., Ltd.) employed as a binder was added. When a complex thereof was formed and the thus obtained solution set into a gel, 30 parts of fine porous grains of a nylon resin (Orgasol 3501 EDXNAT, grain diameter 10 μm: manufactured by ELF ATOCHEM) employed as fine grains of a thermoplastic resin and 100 parts of water were added and the mixture was vigorously stirred at 65° C. for several ten minutes. Thus, a dispersion of the complex was obtained as a coating solution. It was dried at 70° C. for 10 minutes. After heating at 120° C., this transfer layer film showed a permeability at 380 to 730 nm of 80% or more.

On the transfer medium for inkjet recording as described above, an image was formed with the use of an ink jet printer (Model MC2000C manufactured by EPSON) and a water-base pigment ink cartridge for MC use. Subsequently, printing paper sheets (woodfree paper and art paper) were located face-to-face toward the image-receiving layer. Then the transfer layer was adhered to each printing paper with a laminator at 120° C. under a line pressure of 2 kg/cm at a feeding speed of 20 mm/sec. After stripping off the base material, the transfer layer could be clearly transferred without causing any defects. At this point, the difference in 600 gloss between the non-image area of the image-receiving face and each of the art paper and the woodfree paper was 10% or lower. A case where the differences in 60° gloss in both papers were 10% or lower was referred to as having gloss while a case where the difference in one of the papers exceeded 10% was referred to as having no gloss.

The image qualities of the transferred images were evaluated with the naked eye in the following 4 grades.

⊚: Very good.

◯: Good.

Δ: Somewhat poor.

X: Poor.

Table 1 shows the results.

### Comparative Example 1

The procedure of Example 1 was followed but forming no cushion layer. Table 1 shows the evaluation results.

### Examples 2 To 5

The procedure of Example 1 was followed but using BL-1/Oxylac 5H-128 as a binder of the release layer and GANTREZ AN-119 (methyl vinyl ether/maleic anhydride copolymer; manufactured by GOKYO SANGYO K. K.) as a binder of the transfer layer and adding the matt grains in each amount as specified in Table 1. Table 1 shows the evaluation results.

TABLE 1

| | | | Interlayer adhesion | Film thickness | | | |
|---|---|---|---|---|---|---|---|
| | Binder of | Binder of | between release | of image | Addition | Gloss in | |
| | release | transfer | layer/cushion layer | receiving | of matt | non-image | Image |
| | layer | layer | (g/cm) | layer (μm) | grains | area | qualities |
| Ex. 1 | A | B | 25 | 2 | No | Yes | ◯ |
| Ex. 2 | C | D | 20 | 2 | No | Yes | ◯ |
| Ex. 3 | C | D | 30 | 2 | Added to | No | ◯ |
| | | | | | transfer | | |
| | | | | | layer | | |
| Ex. 4 | C | D | 30 | 5 | No | Yes | ⊚ |
| Ex. 5 | C | D | 30 | 2 | Added to | No | ◯ |
| | | | | | release | | |
| | | | | | layer | | |
| C. Ex. 1 | No release | A | 25 | 2 | No | Yes | X |
| | layer | | | | | | |
| | formed | | | | | | |

A: PVB-2000L
B: PVB-205
C: BL-1/Oxylac SH-128
D: GANTREZ AN-119

The results given in Table 1 indicate that, using the transfer media for inkjet recording according to the invention, images with high qualities can be obtained even in the case of transferring onto papers differing in qualities and gloss with high approximation can be achieved in the non-image area.

According to the invention, it is possible to provide a transfer medium for inkjet recording which has a favorable transferability onto various printing papers (i.e., differing in surface roughness, gloss, thickness, surface-treatment on the paper face, etc.) and providing an image having a gloss highly approximate to the printing paper even in a non-image area.

This application is based on Japanese Patent application JP 2003-016369, filed Jan. 24, 2003, the entire content of which is hereby incorporated by reference, the same as if set forth at length.

What is claimed is:

1. A transfer medium for inkjet recording which comprises a base material, a cushion layer, a release layer having a thickness of from 0.02 to 10 μm and a transfer layer having a thickness of from 0.02 to 20 μm.

2. The transfer medium according to claim 1, wherein a permeability of the release layer at from 400 to 700 nm is 70% or more.

3. The transfer medium according to claim 1, wherein a permeability of the release layer at from 400 to 700 nm is 80% or more.

4. The transfer medium according to claim 1, wherein a permeability of the release layer at from 400 to 700 nm is 90% or more.

5. The transfer medium according to claim 1, wherein the transfer layer is capable of absorbing an ink solvent.

6. The transfer medium according to claim 1, wherein the cushion layer is capable of absorbing an ink solvent.

7. The transfer medium according to claim 1, wherein an interlayer adhesion between the release layer and the cushion layer is from 0.5 to 400 g/cm.

8. The transfer medium according to claim 1, wherein an interlayer adhesion between the release layer and the cushion layer is from 2 to 50 g/cm.

9. The transfer medium according to claim 1, wherein the release layer and the transfer layer are simultaneously transferred onto a transfer substrate.

10. The transfer medium according to claim 1, wherein the transfer layer or the release layer comprises matt grains.

11. The transfer medium according to claim 1, wherein the release layer has a thickness of from 0.02 to 1 μm.

12. The transfer medium according to claim 1, wherein the transfer layer comprises a thermoplastic resin.

13. The transfer medium according to claim 12, wherein the thermoplastic resin has a particle size of from 0.05 to 100 μm.

14. The transfer medium according to claim 12, wherein the thermoplastic resin has a melting point of from 70 to 200° C.

15. An image formation method which comprises:
inkjet recording on a transfer face of the transfer medium, the transfer medium comprising abase material, a cushion layer, a release layer having a thickness of from 0.02 to 10 μm and a transfer layer having a thickness of from 0.02 to 20 μm, with the use of an ink containing a pigment or a dye as a coloring matter;
locating face-to-face a transfer substrate and the transfer face of the transfer medium;
heating and pressurizing; and
stripping off the transfer medium from the transfer substrate to thereby transfer the transfer layer and the release layer onto the transfer substrate.

16. The image formation method according to claim 15, wherein the release layer and the transfer layer are simultaneously transferred onto a transfer substrate.
